(19) United States
(12) Patent Application Publication
(10) Pub. No.: US 2026/0179099 A1
(43) Pub. Date: Jun. 25, 2026

(54) TOKEN LINKAGE VIA NEAR FIELD COMMUNICATION

(71) Applicants: American Express Travel Related Services Company, Inc., New York, NY (US); AMEX Canada, Inc., North York (CA)

(72) Inventors: Ashley Sjostrom Brailey, Garwood, NJ (US); Alaric M. Eby, Scottsdale, AZ (US); Sunny D. Hirani, Phoenix, AZ (US); Magdalena McGoldrick, East York (CA); Margaret H. Ryan, Jersey City, NJ (US)

(21) Appl. No.: 18/987,981

(22) Filed: Dec. 19, 2024

(51) Int. Cl. G06Q 20/40

(52) U.S. Cl. CPC G06Q 20/405; G06Q 20/4016

(57) ABSTRACT

Various approaches for an automated selection of a payment instrument based at least part on a token linked to other accounts. In one example, a system, comprising is configured to identify a token payload for authorization of a transaction in which the token payload comprising a token of a user profile. Account identifiers are retrieved based least in part on the user profile. Account identifiers have individual rules that can be applied to the transaction data. A risk assessment score associated with the transaction is determined. The system is configured to select an account identifier among the account identifiers for the transaction based least in part on the risk assessment score and a rule applied to the transaction data. The system is further configured to determine whether to authorize the transaction using the account identifier selected for the transaction.

### BACKGROUND

Customers have multiple payment instruments that can be used for a purchase. Each payment instrument may have a different set of terms, conditions and benefits. Often, customers will use a first payment instrument for certain types of transactions and use a second payment instrument for other types of transactions.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting of a contactless payment transaction according to various embodiments of the present disclosure.

FIG. 2 is a drawing of a network environment according to various embodiments of the present disclosure.

FIG. 3 is a flowchart illustrating one example of functionality implemented as portions of an application executed in a computing environment in the network environment of FIG. 2 according to various embodiments of the present disclosure.

FIG. 4 is a flowchart illustrating one example of functionality implemented as portions of an application executed in a computing environment in the network environment of FIG. 2 according to various embodiments of the present disclosure.

FIG. 5 is a flowchart illustrating one example of functionality implemented as portions of an application executed in a computing environment in the network environment of FIG. 2 according to various embodiments of the present disclosure.

### DETAILED DESCRIPTION

The various embodiments of the present disclosure relate to approaches for an automated selection of a payment instrument for a contactless payment (e.g., near field communication payment) when a user has multiple payment instruments associated with their profile. Often, customers have multiple payment instruments that can be used for a purchase. Each payment instrument may have a different set of terms, conditions and benefits. For example, a customer may have a travel credit card, a cashback credit card, a hotel credit card, a check card, a loyalty points debit card, a gift card, and other types of payment instruments. Often, customers will use a first payment instrument for certain types of transactions and use a second payment instrument for other types of transactions because of the rewards, such as airport lounge assess, cashback, purchase discounts, loyalty points, and other rewards. However, there is a need for improved digital tokenization of payment instruments which can enable an automated process for a selection of a payment instrument among several options for a transaction without human intervention.

For example, a user could have a digital wallet application that manages multiple payment instruments on a mobile device. Each payment instrument can have different terms, conditions, and benefits. Accordingly, a user often has to memorize the advantages and disadvantages for every payment instrument. If they forget, the user could be required to navigate on the mobile device to review information on a small screen. On some mobile devices, such as a smartwatch, the user can have a difficult time selecting a particular payment instrument on a small screen. In some instances, the user may not be able to switch payment instruments for a particular transaction because a default payment instrument is used for all transactions, such as a smartwatch.

In other examples, a user carries multiple physical payment cards with them. At the point-of-sale terminal, the user therefore has to remember which payment card provides the best benefits for the upcoming transaction. This requires that the user's memory be reliable, and that the user is knowledgeable about the current offers, terms, and conditions associated with each payment instrument.

Accordingly, the embodiments of the present disclosure provide several advantages over existing contactless payment mechanisms. For example, various embodiments provide an improved user experience because less user interface selections are performed on the mobile device for a transaction. Various embodiments also enable users to switch payment instruments without human intervention at the point of making the purchase. Further, the various embodiments can provide a faster purchasing process. The user does not need to navigate on a user interface for switching to a different payment instrument because the switch is already performed on behalf of the user. The various embodiments can also enable the user to use one payment instrument that is linked to the multiple other payment instruments. As such, the user does not need to enter multiple payment instruments into their digital wallet application. Nor does the user need to carry multiple physical payment cards. A single payment instrument with a token can be linked to other account identifiers associated with other payment instruments. The embodiments can automate the selection process of an account identifier based at least in part on one or more of transaction data for the purchase, user preference, historical transaction of other users, and other suitable conditions.

The embodiments can include physical or digital payment instruments that are equipped with near field communication (NFC) hardware components for executing contactless transactions. In some examples, the NFC-based payment instruments can indicate to an authorization service that the payment instrument is linked to other payment instruments and a selection process is to be initiated. Further, the embodiments can enable the user to optimize the benefits for selecting a particular payment instrument according to the dynamic conditions associated with each transaction. Lastly, the embodiments can transmit a notification to the mobile device of the user that indicates which payment instrument was selected for the transaction. The notification can be transmitted as the purchase is completed or shortly after the completion of the purchase. The notification can provide one or more links for enabling the user to select a different payment instrument based on the user's preference. As such, after a purchase has been completed, the user can change the payment instrument applied for the purchase in real-time or near real-time.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

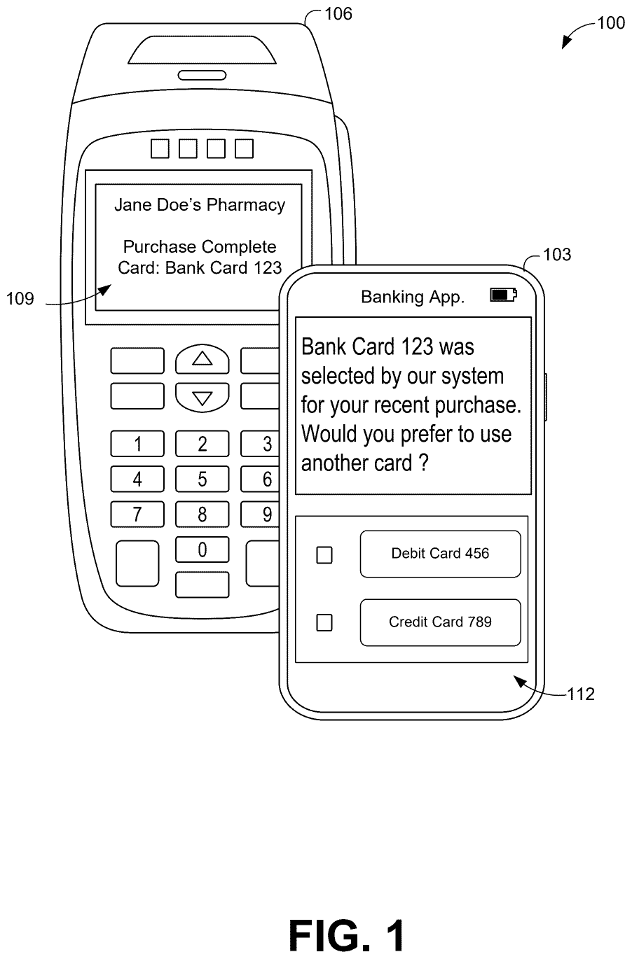

As illustrated in FIG. 1, shown is a drawing of a network environment 100 of a contactless payment between a client device 103 and a point of sale (POS) device 106. In the illustrated example, the client device 103 is a mobile device that is equipped with a first near field communication (NFC) transceiver. The POS device 106 is equipped with a second NFC transceiver and is configured for conducting contactless payments.

In FIG. 1, the POS use interface 109 indicates that the POS device 106 completed a transaction with the client device 103, in which the transaction was conducted via the NFC protocol. The user interface 112 of the client device 103 includes an authorization notification that confirms the completion of the transaction. The authorization notification indicates that Bank Card 123 was automatically selected for the transaction without user involvement. An authorization service selected the Bank Card 123 among multiple payment instruments available in the user's profile based at least in part on one or more conditions associated with the transaction.

For example, the POS device 106 can retrieve a token from the client device 103 via an NFC protocol for a purchase. The token can be stored as a payment instrument in a digital wallet application for the client device 103 or the token can be stored in a NFC-based physical payment card. The token can be linked to several payment instruments (e.g., account identifiers) for a user profile. Each payment instrument can have different benefits. For instance, the authorization service could have selected the Bank Card 123 because Bank Card 123 offers a 3% cashback reward for pharmacy purchases. The other payment instruments for the user could have benefits that are less significant than the 3% cash back for the Bank 123. As such, after the comparison of the payment instruments available for the user, the authorization service can select the Bank 123 card.

Further, after the purchase has been completed, the user interface 112 displays an authorization notification that includes an option for selecting an alternative payment instrument if the user does not agree with the selection of the Bank 123 payment card. Thus, the user could decide that the Credit Card 789 would be a better selection. The user can select the Credit Card 789 option and the client device 103 can transmit the selection of the Credit Card 789 to be used for the transaction.

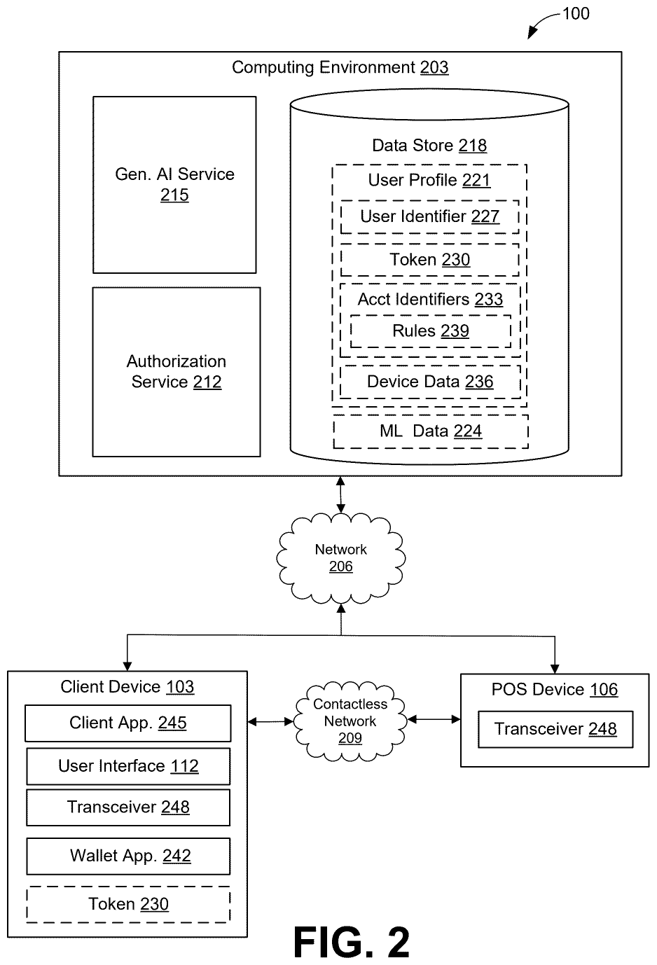

With reference to FIG. 2, shown is a network environment 100 according to various embodiments. The network environment 100 can include a computing environment 203, a client device 103, and the POS device 106, which can be in data communication with each other via a network 206.

The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

The client device 103 and the POS device 106 can be in data communication via a contactless network 209. The contactless network 209 can enable direct communication between the client device 103 and the POS device 106 without the involvement of the network 206. In some examples, the contactless network 209 can represent one or more near field communication (NFC) protocols, one or more BLUETOOTH protocols, and other suitable local contactless networks 209.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include an authorization service 212, a generative artificial intelligence (GenAI) service 215, and other applications, services, processes, systems, engines, or functionality not discussed in detail herein.

The authorization service 212 can be executed to facilitate an automatic selection of a payment instrument (e.g., an account identifier for a financial account) among several available user payment instruments for a transaction. The automatic selection process can be initiated based at least in part on a usage of a particular payment instrument that includes a token which is linked to a plurality of account identifiers of other payment instruments (e.g., credit card, debit cards, gift cards, check cards). The authorization service 212 can select an account identifier for the transaction based at least in part on one or more conditions. In some examples, the authorization service selects the account identifier for optimizing savings or rewards for the user. In some examples, the authorization service 212 can act as an intermediary to the GenAI service 216, which can be used for determining the account identifier 233 for a transaction based at least in part on one or more of the transaction data, data from the user profile 221 of the user conducting the transaction, data from other user profiles 221, and other suitable data.

The GenAI service 215 can be executed to train, generate, validate, test, and deploy machine learning models (e.g., GenAI models such as large language models, etc.) to assist with the selection of an account identifier 233 for transactions. The GenAI service 215 can train the machine learning models for analyzing the information regarding the benefits and rewards associated with each payment instrument. The information can include rules about the user receiving reward points or cash back of a particular percentage for a transaction. The machine learning models can analyze the rules to determine the optimal payment instrument (e.g., an account identifier) for a transaction.

The GenAI service 215 can be executed to receive prompts, process the prompts, and return responses to the prompts based on a machine learning model that has been trained. Accordingly, the GenAI service 215 could act as a front-end to the machine learning model for the authorization service 212. In some instances, the GenAI service 215 could provide an API which could be used to programmatically receive prompts and return responses.

Also, various data is stored in a data store 218 that is accessible to the computing environment 203. The data store 218 can be representative of a plurality of data stores 218, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 218 is associated with the operation of the various applications or functional entities described below. This data can include user profile 221, machine learning data 224, and potentially other data.

The user profile 221 can represent data for a profile or user account associated with individual users. The user profile 221 can include a user identifier 227, a token 230, an account identifier 233, device data 236, and other suitable data. Each user profile 221 can represent a relationship between the user and an organization that operates the computing environment 203.

The token 230 can represent a unique identifier of a payment instrument, such as a physical payment card or a digital payment card. The token can be stored in a controller of the physical payment card (e.g., NFC-based payment card) or can be stored in a wallet application executed in the client device 103. The token 230 can be linked to multiple account identifiers 233 (e.g., credit cards, debit cards, checking cards, gift cards, etc.) of a user. For example, during a transaction at the POS device 106, the payment card provides the token to the POS device 106. Subsequently, the authorization service 212 can decide which of the linked account identifiers 233 should be applied for the transaction. In the physical payment card example, the payment card can include a transceiver, a transceiver Tag, or other suitable component for storing and communicating the token 230.

In some examples, the token 230 can represent a non-financial account for the user. The token 230 can be linked to various membership accounts for access to resources, such as a lounge, a restricted retail area, a gym, a media service, and other restricted areas.

The account identifier 233 can represent individual financial accounts which may each be associated with a payment instrument, such as a credit card, a debit card, a gift card, check chard, a loyalty account, and other suitable payment mechanisms. For example, a travel credit card can have a first account identifier 233 and a cashback credit card can have a second account identifier 233. Each account identifier 233 can include one or more rules 239. The rules 239 can represent terms, conditions, benefits (e.g., membership privileges), rewards (e.g., loyalty points, cashback, discounts on purchases, etc.), and other suitable information associated with using the particular account identifier 233. In some examples, the rules 239 can be described in unstructured text, structured text, one or more parameters, and other suitable means. In the example of unstructured text, the authorization service 212 can use a machine learning model (e.g., a large language model (LLM)) to analyze the unstructured text to compare the unstructured text for the rules 239 associated with each account identifier 233 to determine an account identifier 233 for a transaction.

The device data 236 can represent data associated with a client device 103 of a user. The device data 236 can include device identifiers (e.g., unique mobile device, an Internet Protocol (IP) address, a phone number, etc.), and other suitable device data. In some examples, the device identifier can be linked to a token 230 for security. If an unaffiliated device identifier is associated with the token, then the authorization service 212 can decline the transaction.

The machine learning data 224 can represent data associated with generating, validating, and deploying machine learning models (e.g., GenAI models such as large language models) used for determining a payment instrument (e.g., an account identifier) for a transaction. For example, machine learning models can be generated and used by the authorization service 212 to select the payment instrument. Additionally, the machine learning models can be trained on historical data associated with different conditions (e.g., different user preferences, different transaction types, different payment instruments, etc.). In some examples, the machine learning model can be deployed and executed on the client device 103, in which the client device 103 can select a payment instrument without the involvement of the computing environment 203.

In some examples, the machine learning models are GenAI models (e.g., large language models (LLMs)). During an authorization request, the authorization service 212 can submit a request to the GenAI service 215 for a selection of the account identifier 233. The authorization service 212 can use prompt engineering or augmentation techniques to improve the quality of the response from the GenAI service 215.

For example, the authorization service 212 could use retrieval augmented generation (RAG) to improve the response from the GenAI service 215 by submitting a query to internal or external data sources (e.g., databases, knowledgebases, web pages) relating to updated data for the user profiles 221 (e.g., account information, balance information, etc.) and the payment instruments associated with the user profile 221. The internal or external data sources can provide updated information on the rules 239 related to each payment instrument and updated information on the user profile 221 (e.g., current account balances, current list of account identifiers 233).

With the updated data, the authorization service 212 can generate an augmented prompt that includes the updated data, the transaction data, and data from the user profile 221. The authorization service 212 can provide the augmented prompt to the GenAI service 215. In response, the GenAI service 215 can be provide a selected payment instrument.

The machine learning model data 224 can include data that relates to which features (e.g., variables) are selected for optimizing machine learning models for selecting a payment instrument and/or account identifier for a transaction. A machine learning model can be a file that is generated from executing a machine learning algorithm based at least in part on a training data set. Each machine learning model can include rules, patterns, values, and/or other aspects related to making a selection. The machine learning models can be generated using one or more classification algorithms, such as decision tree, linear regression, logistic regression, artificial neural network, k-nearest neighbors, k-means, and other suitable machine learning algorithms.

The client device 103 is representative of a plurality of client devices that can be coupled to the network 206. The client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 103 or can be connected to the client device 103 through a wired or wireless connection.

The client device 103 can be configured to execute various applications such as a wallet application 242, a client application 245, or other applications. The wallet application 242 can executed to complete purchases with a POS device 104. The wallet application 242 can provide access to one or more digital payment instruments for the user profile 221. In the embodiments of the present disclosure, the wallet application 242 can use a single payment instrument associated with the token 230. The token 230 can be linked to multiple account identifiers 233. As such, the user can load a single payment instrument that has the token 230 and the single payment instrument provides the user access to the other linked payment instruments.

The client application 245 can be executed to facilitate the selection of the account identifier 233 for a payment instrument. In some examples, the client application 245 can be associated with a financial entity. The client application 245 can be set user preferences for facilitate with the automated selection of the account identifier 233 at a transaction. In some examples, the client application 245 can be executed to automate a selection of a payment instrument using a GenAI model, in which the GenAI model selects the payment instrument among several options. The client application 245 can be executed in a client device 103 to access network content served up by the computing environment 203 or other servers, thereby rendering a user interface 112 on the display. To this end, the client application 245 can include a browser, a dedicated application, or other executable, and the user interface 112 can include a network page, an application screen, or other user mechanism for obtaining user input. The client device 103 can be configured to execute applications beyond the client application 245 such as email applications, social networking applications, word processors, spreadsheets, or other applications.

The client device 103 can also include a transceiver 248 for data communication. The transceiver 248 can represent one or more transceivers that communicate according to various wireless communication protocols. For example, the transceiver 248 can represent a near field communication (NFC) transceiver that communicates according to one or more NFC communication protocols with the POS device 106. In this instance, the contactless network 209 can represent one or more NFC communication protocols that are used to execute a contactless transaction between the client device 103 or a payment card and the POS device 106.

The POS device 106 can represent a merchant device that is used to execute a purchase of an item or service with the client device 103 and a payment card (e.g., an NFC-enabled chip payment card). The POS device 106 can include the transceiver 248 for executing communicating over the contactless network 209 with the client device 103 or a payment card.

Next, a general description of the operation of the various components of the network environment 100 is provided. To begin, a user can have a wallet application 242 on a client device 103. The wallet application 242 can have access to a linked payment instrument which stores a token 230. During a contactless payment (e.g., NFC payment), the token 230 of the linked payment instrument enables for the automatic selection of an account identifier 233 among several account identifiers 233 owned the user. Of the several account identifiers 233, each account identifier 223 can represent an individual payment instrument owned by the user. Thus, the automatic selection process occurs without human involvement. The user is enabled to use a single linked payment instrument which can cause a selection of one among several account identifier 233 for a particular transaction. The selection of the account identifier 233 can be determined based at least in part on unique conditions associated with each transaction.

In a first example, the user can make a first purchase at a physical grocery store with a linked payment instrument that has a token 230. The user may have a first payment instrument and a second payment instrument, which are linked to the linked payment instrument. The first payment instrument may have a first account identifier 233 that provides 5% cashback rewards (e.g., a first rule 239) for only purchases at grocery stores. The second payment instrument may have a second account identifier 233 that provides 2% cashback rewards (e.g., a second rule 239) for all purchases.

In this first example, the authorization service 212 can select the first account identifier 233 after receiving a token payload that includes the token 230 from the linked payment instrument. The authorization service 212 can select the first account identifier 233 based at least in part on the transaction data and the first rule 239. The transaction data can indicate that the transaction is at a grocery store. The authorization service 212 can compare the first rule 239 and the second rule 239 for the second account identifier and can determine that the first account identifier 233 is more advantageous because of the 5% cashback associated with the first rule 239.

In a second example subsequently, the authorization service 212 can select the second account identifier 233 after receiving a token payload that includes the token 230 from the linked payment instrument. In this transaction, the authorization service 212 can determine the 2% cashback for the second account identifier 233 is more advantageous then 0% cashback associated with the first account identifier 233. As such, the user used the same linked payment instrument for two separate transactions and the authorization service used different account identifiers 244 based at least in part on the transaction data and the rules 239 associated with each account identifier 233. Thus, the user can carry one payment instrument and take advantage of the benefits provided for each account identifier 233.

In some examples, the linked payment instrument (e.g., a physical payment instrument or a digital payment instrument) that stores the token 230 includes NFC-based hardware components (e.g., an NFC transceiver 248). The NFC-based hardware component can enable the linked payment instrument to indicate that the token 230 is linked to other payment instruments (e.g., other account identifiers 233) and that a selection of the account identifier 233 should be initiated for the authorization request of the transaction. The NFC-based linked payment instrument for the token 230 can indicate this instruction in an NFC-based data element that is included in the token payload.

Further, in some examples, the NFC-based linked payment instrument or the client device 103 can generate a cryptogram based at least in part on an NFC session (e.g., the contactless network 209) between the NFC-based linked payment instrument or the client device 103 and an NFC-based transceiver 248 of the POS device 106. During the NFC session, the POS device 106 can provide transaction data to the NFC-based linked payment instrument or the client device 103. In turn, the NFC-based linked payment instrument or the client device 103 can generate a cryptogram based at least in part on the token 230 and the transaction data. The cryptogram can be encrypted using an encryption key stored on the client device 103 or the NFC-based linked payment instrument. The client device 103 or the NFC-based linked payment instrument can provide the cryptogram to the POS device 106 via the NFC session. The POS device 106 can generate a token payload that includes the cryptogram and other transaction data to the authorization service 212.

The authorization service 212 can identify the token 230 from token payload. Additionally, the authorization service 212 can initiate a selection process for determining an account identifier 233 for the transaction based at least in part on the token 230, an NFC-based data element associated with the token payload, or other suitable mechanisms. The authorization service 212 can select on an account identifier 233 based at least in part on one or more conditions, such as user preferences, rules 239, transaction history, transaction data, and other suitable elements. In some examples, the authorization service 212 can use a GenAI model, such as an LLM, for determining the account identifier 233.

In some examples, the client application 245 and/or the wallet application 242 can display a user interface 112 for configuring user preferences for facilitating a selection of an account identifier 233. The user preferences can include a preference to use a particular account identifier 233 for a merchant category, a merchant brand, a transaction location, a purchase that exceeds a threshold amount, a transaction date, an optimization for loyalty points, an optimization for cashback, and other suitable conditions.

Accordingly, the embodiments enable for a single linked payment instrument that can used to optimize a selection of an account identifier among several options. Thus, the user only needs to enter one payment instrument into a wallet application 242 or the user only needs to carry one payment instrument.

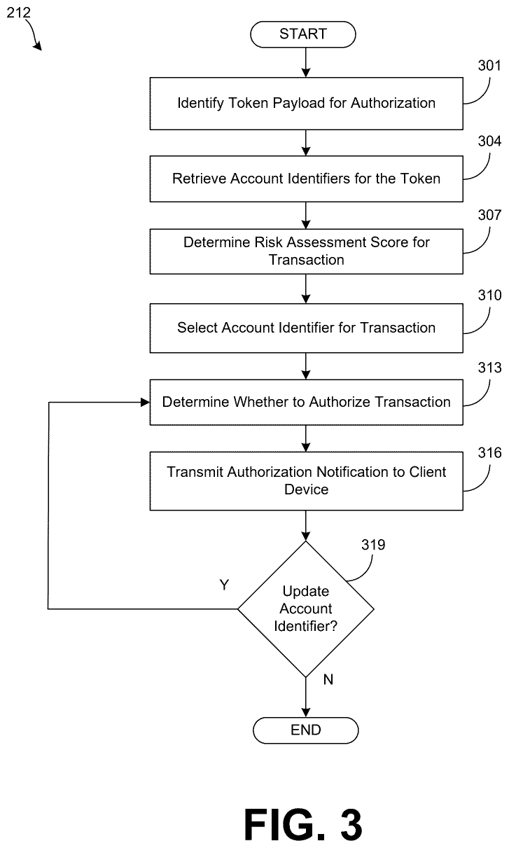

Turning now to FIG. 3, shown is a flowchart that provides one example of the operation of a portion of the authorization service 212. The flowchart of FIG. 3 provides merely an example of the many different types of functional arrangements that can be employed to implement the operation of the depicted portion of authorization service 212. As an alternative, the flowchart of FIG. 3 can be viewed as depicting an example of elements of a method implemented within the network environment 100.

In the described examples for FIG. 3, the token 230 is stored on a payment instrument, such as a physical payment card and/or a digital payment card stored in the wallet application 242. The user has multiple payment instruments (e.g., multiple account identifiers 233) that are associated or linked to the token 230 because of the user profile 221.

Beginning with block 301, the authorization service 212 can identify a token payload for authorization of a pending transaction. The token payload can be received from the POS device 106. The token payload can include a token 230 for representing two or more account identifier 233, transaction data (e.g., transaction amount, transaction type, transaction location, transaction date, merchant information, etc.), an application transaction counter, and other suitable data. The token 230 (e.g., a token identifier) can be linked to a user profile 221.

In some examples, the token payload can comprise a cryptogram that has been generated using the token 230 and an encryption key stored in the payment card and/or the wallet application 242. The cryptogram can be a dynamic one-time use code that is uniquely generated for each transaction. The corresponding decryption key can be stored in the user profile 221 of the computing environment 203 and can be used to decrypt/validate the cryptogram.

In block 304, the authorization service 212 can retrieve a plurality of account identifiers 233 for the token 230 of a particular user profile 221. The authorization service 212 can use the token 230 (e.g., a token identifier) to identify a user profile 221 and the associated account identifiers 233 for the token 230. Additionally, the authorization service 212 can identify one or more rules 239.

In block 307, the authorization service 212 can determine a risk assessment score for the transaction. In some examples, the authorization service 212 can use one or more risk assessments techniques for generating a risk assessment score. For example, the authorization service 212 can generate the risk assessment score based at least in part on the application transaction counter, the transaction location, a verification of the cryptogram, device data 236, a transaction history for the user profile 221, and other suitable factors.

In block 310, the authorization service 212 can select an account identifier 233 for the transaction based at least in part on one or more of the rules 239 associated with the account identifier 233, the transaction data, the risk assessment score, and other suitable data. Additionally, the authorization service 212 can consider other inputs such as transaction history for the user profile, merchant information to identify related promotional offers and benefits, user preferences, and other related data. The risk assessment score can be generate based at least in part on the data for the merchant and/or the user. The data can be provided from internal or external data sources.

In some examples, the authorization service 212 can query a machine learning model (e.g., a GenAI model, such as an LLM) to select the account identifier 233 for the transaction. The machine learning model can be provided the inputs described above. The machine learning model can be used to analyze the rules 239 associated with each account identifier 233. For example, the rules 239 may include unstructured or semi-structured text. The machine learning model can be executed to compare the unstructured or semi-structured text of various rules 239 and determine the optimized account identifier 233 for the transaction.

In some examples, the authorization service 212 can use a retrieval augment generation (RAG) in association with the machine learning model (e.g., a GenAI model, such as an LLM) to generate the selection of the account identifier 233. For example, the authorization service 212 could use RAG techniques for submitting a query to internal or external data sources (e.g., databases, knowledgebases, web pages) for updated data for the rules 239 (e.g., dynamic promotional offers), account identifiers 233 (e.g., balance information, etc.) and other suitable data. For instance, the terms and conditions of the rules 239 can dynamically change in which the text for the rules 239 has changed. With the updated data, the authorization service 212 can generate an augmented prompt that includes the updated data, the transaction data, and data from the user profile 221. The augmented prompt is provided to the GenAI service 215. In response, the GenAI service 215 can be provide a selected payment instrument using the GenAI model, such as an LLM or other suitable GenAI models.

In block 313, the authorization service 212 can determine whether to authorize the transaction based at least part on the selected account identifier 233. In some examples, the authorization service 212 can verify that there is sufficient funds and/or credit associated with account identifier 233. The authorization service 212 can perform other authorization and fraud analysis in determining whether to authorize the transaction.

In block 316, the authorization service 212 can transmit an authorization notification to the POS device 106 and the client device 103. The authorization notification can indicate whether the authorization service 212 has approved or denied the transaction. If the transaction is approved, the authorization notification can include an authorization code for the merchant, an indication of the selected account identifier 233 for the transaction, and other suitable transaction data.

Additionally, the authorization service 212 can transmit the authorization notification to the client device 103, which can include similar information that was approved to the POS device 106. In some examples, the authorization notification can be a push notification that is provided in real-time or near real-time.

In addition to indicating the selected account identifier 233, the authorization notification can include a user interface component for altering the selected account identifier 233 even after the authorization of the notification. For example, the user may prefer that a different account identifier 233 be used for the transaction.

In block 319, the authorization service 212 can determine whether to update the account identifier 233 for the transaction based at least in part on whether the user has selected one or more user interface components. For example, the user can select a user interface component on the authorization notification, which can generate a change request for the account identifier. In some examples, the user interface component is a deep link that activates the client application 245 to display a user interface 112 for receiving an updated account identifier 233. The deep link can have an embedded parameter that directs the client application 245 to display the user interface 112 and include transaction data for the transaction. For example, the embedded parameter can be referenced to display the transaction data and/or other account identifiers 233 that are available for the selection.

Upon a selection of an updated account identifier 233, the client application 245 can transmit the updated account identifier 233 to the authorization service 212. Accordingly, if the authorization service 212 receives an indication that the user has provided an updated account identifier 233, then the authorization service 212 can proceed to the 313. The authorization service 212 can determine whether to authorization the transaction with the updated account identifier 233. Upon authorization, the authorization service 212 can transmit an updated authorization notification to the client device 103. Alternatively, if the authorization service 212 does not receive an indication of an updated account identifier 233, then the authorization service 212 proceeds to the end.

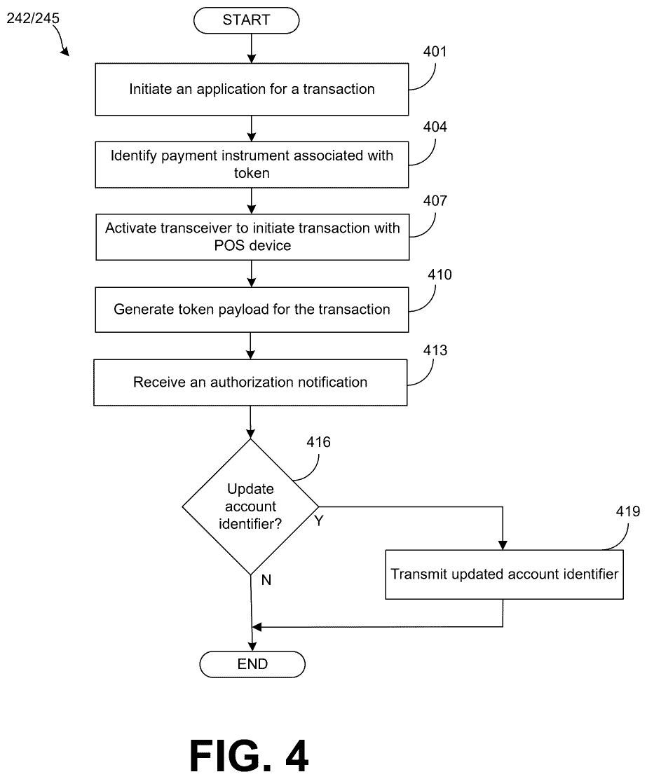

Moving on to FIG. 4, shown is a flowchart that provides one example of the operation of a portion of the wallet application 242. The flowchart of FIG. 4 provides merely an example of the many different types of functional arrangements that can be employed to implement the operation of the depicted portion of the wallet application 242. As an alternative, the flowchart of FIG. 4 can be viewed as depicting an example of elements of a method implemented within the network environment 100. Additionally, the client application 245 can be executed to perform one or more components of the flowchart of FIG. 4.

Beginning with block 401, the wallet application 242 can be initiated for engaging in a transaction with a POS device 106. In some examples, the wallet application 242 can perform a biometric scan of the user using a biometric sensor. The biometric sensor can include a camera, a fingerprint sensor, a microphone, and other suitable biometric sensors. After verifying the biometric scan is complete, the wallet application 242 can proceed to block 404.

In block 404, the wallet application 242 can identify a payment instrument that has been selected for a transaction. The selected payment instrument can be associated with the token 230 and the token 230 can be linked to multiple account identifiers 233.

In block 407, the wallet application 242 can activate the transceiver 248 to initiate the transaction with the POS device 106 by way of the contactless network 209 (e.g., an NFC communication protocol). For example, the wallet application 242 initiate an NFC session (e.g., contactless network 209) with the POS device 106. The wallet application 242 can retrieve transaction data from the POS device 106, which can include one or more elements such as a transaction amount, a transaction location, a merchant identifier, and other suitable data.

In block 410, the wallet application 242 can generate a token payload using the token 230. The wallet application 242 can generate the token payload to include the token 230, the transaction data, data security elements, and other suitable elements. The wallet application 242 can transmit the token payload to the POS device 106, and the POS device 106 can transmit the token payload to the authorization service 212.

In some examples, the authorization service 212 can select an account identifier 233 for the token 230 based at least part on data associated with the user profile 221, transaction data, risk assessment data, user preferences, and other suitable data. The authorization service 212 can retrieve a set of account identifiers 233 associated with the token 230. The authorization service 212 can automatically select one of the account identifiers 233 to use for the transaction.

In some examples, the client application 245 and/or the wallet application 242 can select the account identifier 233 for the token 230. For example, the client application 245 and/or the wallet application 242 can receive transaction data from the POS device 106 during the initiation of the contactless transaction. The client application 245 and/or the wallet application 242 can query a GenAI model with the transaction data, the available payment instruments (e.g., account identifiers 233) associated with the wallet application 242, historical data, and other suitable data. In response, the GenAI model can provide a selected account identifier 233. In some examples, the GenAI model can be executed on the client device 103 or can be accessed at the computing environment 203 by the client device 103.

In some examples, the wallet application 242 generates a cryptogram using the token 230, an encryption key, the transaction data, and other suitable elements. The POS device 106 can include the cryptogram in the token payload, which is transmitted to the authorization service 212. The authorization service 212 can use a decryption key for verifying authenticity of the cryptogram.

In block 413, the wallet application 242 can receive an authorization notification from the authorization service 212. The authorization notification can include an indication of whether the transaction was approved or declined. Further, the authorization service 212 can indicate the account identifier 233 that was used for the transaction.

In block 416, the wallet application 242 can determine whether a selection has been made for updating the account identifiers 233 based at least in part on a selection of a user interface component. In some examples, the user interface component can be displayed in association with the authorization notification. If a user interface component has been selected for updating the account identifier 233, then the wallet application 242 can proceed to block 419. If a user interface component has not been selected, then the wallet application 242 can proceed to the end.

In block 419, the wallet application 242 transmit an update account identifier 233 to the authorization service 212. In some examples, the authorization notification is displayed on the user interface 112 and the user interface 112 can include user interface options for selecting an updated account identifier 233. In other examples, the authorization notification can include a deep link to the client application 245. Upon selection of the deep link, the client application 245 can be executed to receive a selection of the updated account identifier 233. Then, the wallet application 242 proceeds to the end.

In some examples, the client application 245 can be executed to make a purchase over the contactless network 209 (e.g., NFC protocol) with an NFC equipped POS device 106. The client application 245 can be executed to make a selection of a payment instrument by collecting transaction data and using an GenAI model (e.g., either locally on the client device 103 or via the GenAI service 215). Upon a selection of the payment instrument, the client application 245 can generate a token payload to include a token identifier associated with the selected payment instrument. In some examples, the client application 245 can provide to the GenAI model merchant location information, transaction data (e.g., purchase type, purchase amount, etc.), available payment instrument, historical transaction data, and other suitable data to the GenAI model for the selection.

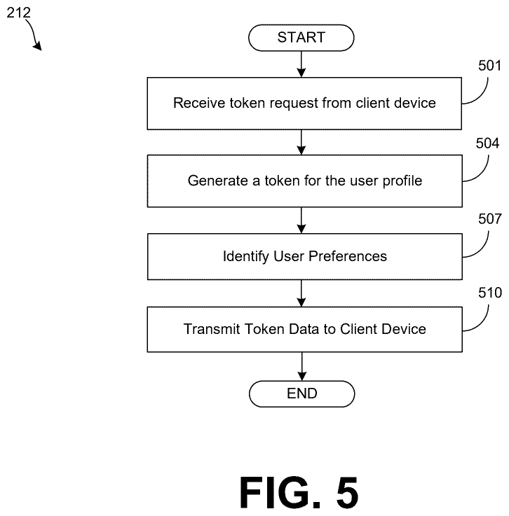

Referring next to FIG. 5, shown is a flowchart that provides one example of the operation of a portion of the authorization service 212. The flowchart of FIG. 5 provides merely an example of the many different types of functional arrangements that can be employed to implement the operation of the depicted portion of the authorization service 212. As an alternative, the flowchart of FIG. 5 can be viewed as depicting an example of elements of a method implemented within the network environment 100.

Beginning with block 501, the authorization service 212 can receive a token request from a client device 103. In some examples, the client device 103 can initiate the token request from the client application 245, which may be a financial services application. In other examples, the client device 103 can initiate token request from the wallet application 242. The token request can include a user identifier 227 for identifying the user profile 221 of the user. In some examples, the token request can be generated by the wallet application 242 and/or the client application 245. In either of these applications, the user may initiate the token request by selecting an add payment instrument button.

In block 504, the authorization service 212 can generate a token 230 for the user profile 221 of the user. The authorization service 212 can identity two or more account identifiers 233 associated with the user profile 221 of the user. The identified two or more account identifiers 233 can be associated with the generated token 230 in the user profile 221.

In block 507, the authorization service 212 can identify user preferences received from the client device 103. The user preferences can be configured by the user and stored in the user profile 221 at the data store 218. In some examples, the user preferences can include a specification of instructions for using a particular account identifier 233 (e.g., payment instrument) for certain conditions. For example, a user preference can specify to the user a particular account identifier 233 for a particular purchase category or a particular merchant.

In block 510, the authorization service 212 can transmit token data to the client device 103. The client device 103 can receive token data and stored the token data. The wallet application 242 can access to the token 230 from the token data for contactless purchases.

In some examples, the authorization service 212 can provide the token 230, a cryptographic key, and other suitable data to the wallet application 242. The wallet application 242 and/or the client application 245 can use the cryptographic key to encrypt data elements for a transaction. Then, the authorization service 212 can proceed to the end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3-5 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts of FIGS. 3-5 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts of FIGS. 3-5 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine-readable instructions stored in the memory that, when executed by the processor, cause the computing device to at least:
identify a token payload for authorization of a transaction, the token payload comprising a token of a user profile and transaction data;
retrieve a plurality of account identifiers based least in part on the user profile, the plurality account identifiers having a rule applied to the transaction data;
determine a risk assessment score associated with the transaction;
select an account identifier among the plurality of account identifiers for the transaction based least in part on the risk assessment score and the rule applied to the transaction data; and
determine whether to authorize the transaction using the account identifier selected for the transaction.

2. The system of claim 1, wherein the selection of the account identifier is based at least in part on a machine learning model, the machine learning model having been trained on the rule applied the transaction data and historical transaction data.

3. The system of claim 1, wherein the machine-readable instructions further cause the computing device to at least:
identify a device identifier associated with the token; and
transmit an authorization notification to a client device associated with the device identifier, the authorization notification indicating the account identifier selected for the transaction.

4. The system of claim 3, wherein the machine-readable instructions further cause the computing device to at least:
receive from the client device an indication of a change request for the account identifier selected for the transaction;
identify an updated account identifier from the client device; and
determine whether to authorize the transaction using the updated account identifier.

5. The system of claim 3, wherein the determination of the risk assessment score associated with the transaction is further based at least in part on at least one of historical merchant data associated with a merchant identifier for the transaction or historical transaction data associated with a user profile for the token.

6. The system of claim 1, wherein the rule comprises identifying a merchant type or an item type for the transaction from the transaction data, and the selection of the account identifier is further based at least in part on a machine learning model being provided an input of the merchant type for the transaction.

7. The system of claim 1, wherein the rule comprises identifying a transaction history for the user profile, and the selection of the account identifier is further based at least in part on a machine learning model being provided an input of the transaction history for the user profile.

8. A method, comprising:
identifying, by a computing device, a token payload for authorization of a transaction, the token payload comprising a token of a user profile and transaction data;
retrieving, by the computing device, a plurality of account identifiers based least in part on the user profile, the plurality account identifiers having a rule applied to the transaction data;
determining, by the computing device, a risk assessment score associated with the transaction;
selecting, by the computing device, an account identifier among the plurality of account identifiers for the transaction based least in part on the risk assessment score and the rule applied to the transaction data; and
determining, by the computing device, whether to authorize the transaction using the account identifier selected for the transaction.

9. The method of claim 8, wherein selecting the account identifier is further is based at least in part on a machine learning model, the machine learning model having been trained on the rule applied the transaction data and historical transaction data.

10. The method of claim 8, further comprising:
identifying, by the computing device, a device identifier associated with the token; and
transmitting, by the computing device, an authorization notification to a client device associated with the device identifier, the authorization notification indicating the account identifier selected for the transaction.

11. The method of claim 10, further comprising:
receiving, by the computing device, from the client device an indication of a change request for the account identifier selected for the transaction;
identifying, by the computing device, an updated account identifier from the client device; and
determining, by the computing device, whether to authorize the transaction using the updated account identifier.

12. The method of claim 1 wherein determining the risk assessment score associated with the transaction is further based at least in part on at least one of historical merchant data associated with a merchant identifier for the transaction or historical transaction data associated with a user profile for the token.

13. The method of claim 8, wherein the rule comprises identifying a merchant type or an item type for the transaction from the transaction data, and the selection of the account identifier is further based at least in part on a machine learning model being provided an input of the merchant type for the transaction.

14. The method of claim 8, wherein the rule comprises identifying a transaction history for the user profile, and the selection of the account identifier is further based at least in part on a machine learning model being provided an input of the transaction history for the user profile.

15. (canceled)

16. (canceled)

17. (canceled)

18. (canceled)

19. (canceled)

20. (canceled)

21. A non-transitory, computer-readable medium, comprising machine-readable instructions that, when executed by a processor of a computing device, cause the computing device to at least:
identify a token payload for authorization of a transaction, the token payload comprising a token of a user profile and transaction data;
retrieve a plurality of account identifiers based least in part on the user profile, the plurality account identifiers having a rule applied to the transaction data;
determine a risk assessment score associated with the transaction;
select an account identifier among the plurality of account identifiers for the transaction based least in part on the risk assessment score and the rule applied to the transaction data; and
determine whether to authorize the transaction using the account identifier selected for the transaction.

22. The non-transitory, computer-readable medium of claim 21, wherein the selection of the account identifier is based at least in part on a machine learning model, the machine learning model having been trained on the rule applied the transaction data and historical transaction data.

23. The non-transitory, computer-readable medium of claim 21, wherein the machine-readable instructions, when executed by the processor, further cause the computing device to at least:
identify a device identifier associated with the token; and
transmit an authorization notification to a client device associated with the device identifier, the authorization notification indicating the account identifier selected for the transaction.

24. The non-transitory, computer-readable medium of claim 23, wherein the machine-readable instructions further cause the computing device to at least:
receive from the client device an indication of a change request for the account identifier selected for the transaction;
identify an updated account identifier from the client device; and
determine whether to authorize the transaction using the updated account identifier.

25. The non-transitory, computer-readable medium of claim 23, wherein the determination of the risk assessment score associated with the transaction is further based at least in part on at least one of historical merchant data associated with a merchant identifier for the transaction or historical transaction data associated with a user profile for the token.

26. The non-transitory, computer-readable medium of claim 21, wherein the rule comprises identifying a merchant type or an item type for the transaction from the transaction data, and the selection of the account identifier is further based at least in part on a machine learning model being provided an input of the merchant type for the transaction.
